(19) United States
(12) Patent Application Publication
(10) Pub. No.: US 2014/0047161 A1
(43) Pub. Date: Feb. 13, 2014

(54) System Employing MRAM and Physically Addressed Solid State Disk

(71) Applicant: AVALANCHE TECHNOLOGY, INC., (US)

(72) Inventor: Siamack Nemazie, Los Altos Hills, CA (US)

(73) Assignee: AVALANCHE TECHNOLOGY, INC., Fremont, CA (US)

(21) Appl. No.: 13/673,866

(22) Filed: Nov. 9, 2012

Related U.S. Application Data
(63) Continuation-in-part of application No. 13/570,202, filed on Aug. 8, 2012.

(51) Int. Cl. G06F 12/02

(52) U.S. Cl. CPC G06F 12/0246
USPC 711/103

(57) ABSTRACT

A computer system includes a Central Processing Unit (CPU) that has a physically-addressed solid state disk (SSD), addressable using physical addresses associated with user data and provided by a host. The user data is to be stored in or retrieved from the physically-addressed SSD in blocks. Further, a non-volatile memory module is coupled to the CPU and includes flash tables used to manage blocks in the physically addressed SSD. The flash tables have tables that are used to map logical to physical blocks for identifying the location of stored data in the physically addressed SSD. The flash tables are maintained in the non-volatile memory modules thereby avoiding reconstruction of the flash tables upon power interruption.

### CROSS REFERENCE TO RELATED APPLICATIONS

This application is a continuation-in-part of U.S. patent application Ser. No. 13/570,202, filed on Aug. 8, 2012, by Siamack Nemazie and Ngon Van Le, and entitled “SOLID STATE DISK EMPLOYING FLASH AND MAGNETIC RANDOM ACCESS MEMORY (MRAM)”, which claims priority U.S. Provisional Application No. 61/538,697, filed on Sep. 23, 2011, entitled “Solid State Disk Employing Flash and MRAM”, by Siamack Nemazie, incorporated herein by reference as though set forth in full.

### BACKGROUND OF THE INVENTION

1. Field of the Invention

This invention relates generally to computer systems and particularly to computer systems utilizing physically-addressed solid state disk (SSD).

2. Background

Solid State Drives (SSDs) using flash memories have become a viable alternative to Hard Disc Drives in many applications. Such applications include storage for notebook, tablets, servers and network attached storage appliances. In notebook and tablet applications, storage capacity is not too high, and power and or weight and form factor are key metric. In server applications power and performance (sustained read/write, random read/write) are key metrics. In network attached storage appliances capacity, power and performance are key metrics, and capacity is achieved by employing a plurality of SSDs in the appliance. The SSD may be directly attached to the system via a bus such as SATA, SAS or PCIe.

Flash memory is a block based non-volatile memory with each block is organized into and made of various pages. After a block is programmed it must be erased prior to programming it again, most flash memory require sequential programming of pages within a block. Another limitation of flash memory is that blocks can be erased for a limited number of times, thus frequent erase operations reduce the life time of the flash memory. A Flash memory does not allow in-place updates. That is it cannot overwrite new data into existing data. The new data are written to erased areas (out-of-place updates), and the old data are invalidated for reclamation in the future. This out-of-place update causes the coexistence of invalid (i.e. outdated) and valid data in the same block. Garbage Collection is the process to reclaim the space occupied by the invalid data, by moving valid data to a new block and erasing the old block. Garbage collection results in significant performance overhead as well as unpredictable operational latency. As mentioned flash memory blocks can be erased for a limited number of times. Wear leveling is the process to improve flash memory life time by evenly distributing erases over the entire flash memory (within a band).

The management of blocks within flash based memory system including SSDs is referred to as flash block management and includes: Logical to Physical Mapping, Defect management for managing defective blocks (blocks that were identified to be defective at manufacturing and grown defective blocks thereafter), wear leveling to keep program/erase cycle of blocks within a band, keeping track of free available blocks, garbage collection for collecting valid pages from a plurality of blocks (with a mix of valid and invalid page) into one block and in the process creating free blocks. The flash block management requires maintaining various tables referred to as flash block management tables (or “flash tables”). These tables are generally proportional to the capacity of SSD. Generally the flash block management tables can be constructed from metadata maintained on flash pages. Metadata is non-user information written on a page. Such reconstruction is time consuming and generally performed very infrequently upon recovery during power up from a failure (such as power fail).). In one prior art technique, technique the flash block management tables are maintained in a volatile memory, and as mentioned the flash block management tables is constructed from metadata maintained on flash pages during power up. In another prior art technique, the flash block management tables are maintained in a battery-backed volatile memory, utilized to maintain the contents of volatile memory for an extended period of time until power is back and tables can be saved in flash memory. In yet another prior art technique the flash block management tables are maintained in a volatile RAM, the flash block management tables are periodically and/or based on some events (such as a Sleep Command) saved (copied) back to flash, and to avoid the time consuming reconstruction upon power up from a power failure additionally a power back-up means provides enough power to save the flash block management tables in the flash in the event of a power failure. Such power back-up may comprise of a battery, a rechargeable battery, or a dynamically charged super capacitor.

The flash block management is generally performed in the SSD and the tables reside in the SSD. Alternatively the flash block management may be performed in the system by a software or hardware, commands additionally include commands for flash management commands and the commands use physical address rather than logical address. An SSD wherein the command use physical address is referred to as Physically Addressed SSD. The flash block management tables are maintained on the (volatile) system memory.

In a system employing physically addressed SSD which maintains the flash block management tables on the system memory that has no power back means for the system and no power back means for the system memory, the flash block management tables that resides in the system memory will be lost and if copies are maintained in the flash onboard the SSD, the copies may not be updated and/or may be corrupted if power failure occurs during the time a table is being saved (or updated) in the flash memory. Hence, during a subsequent power up, during initialization the tables have to be inspected for corruption due to power fail and if necessary recovered. The recovery requires reconstruction of the tables to be completed by reading metadata from flash pages and results in further increase in delay for system to complete initialization. The process of completely reconstruction of all tables is time consuming, as it requires metadata on all pages of SSD to be read and processed to reconstruct the tables. Metadata is non-user information written on a page. This flash block management table recovery during power up will further delay the system initialization, the time to initialize the system is a key metric in many applications.

As mentioned before in some prior art techniques, a battery-backed volatile memory is utilized to maintain the contents of volatile memory for an extended period of time until power is back and tables can be saved in flash memory.

Battery backup solutions for saving system management data or cached user data during unplanned shutdowns are long-established but have certain disadvantage including up-front costs, replacement costs, service calls, disposal costs, system space limitations, reliability and “green” content requirements.

What is needed is a system employing physically addressed SSD to reliably and efficiently preserve flash block management tables in the event of a power interruption.

### SUMMARY OF THE INVENTION

Briefly, a computer system includes a Central Processing Unit (CPU) that has a physically-addressed solid state disk (SSD), addressable using physical addresses associated with user data and provided by a host. The user data is to be stored in or retrieved from the physically-addressed SSD in blocks. Further, a non-volatile memory module is coupled to the CPU and includes flash tables used to manage blocks in the physically addressed SSD. The flash tables have tables that are used to map logical to physical blocks for identifying the location of stored data in the physically addressed SSD. The flash tables are maintained in the non-volatile memory modules thereby avoiding reconstruction of the flash tables upon power interruption.

In one embodiment all flash block management tables are in one or more non-volatile memory module comprised of MRAM coupled to processor though memory channels.

In an alternate embodiment tables are maintained in system memory and are near periodically saved in flash onboard the physically addressed SSD and the parts of the tables that are updated since last save are additionally maintained in non-volatile memory module comprised of MRAM coupled to processor though memory channels, wherein the current version of the block management table in flash along with the updates saved in MRAM is used to reconstruct the flash block management tables in system memory upon system power up. In yet another alternate embodiment in order to reduce the size of updates in MRAM and frequency of flash table copy back to flash, one or more of the updates (along with revision number are additionally saved in Flash are also copied to flash wherein the current version of the block management table in flash along with past updates saved in flash and recent updates saved in MRAM is used to reconstruct the flash block management tables in system memory upon system power up.

In yet another embodiment the MRAM instead of being coupled through a memory channel is coupled to processor through a system bus such as Serial Peripheral Interface (SPI) bus, wherein the same methods are used to reconstruct the flash block management tables in system memory upon system power up, specifically either using the current version of the block management table in flash along with recent updates saved in MRAM or using the current version of the block management table in flash along with past updates saved in flash and recent updates saved in MRAM is used to reconstruct the flash block management tables in system memory upon up. These and other objects and advantages of the invention will no doubt become apparent to those skilled in the art after having read the following detailed description of the various embodiments illustrated in the several figures of the drawing.

In the Drawings

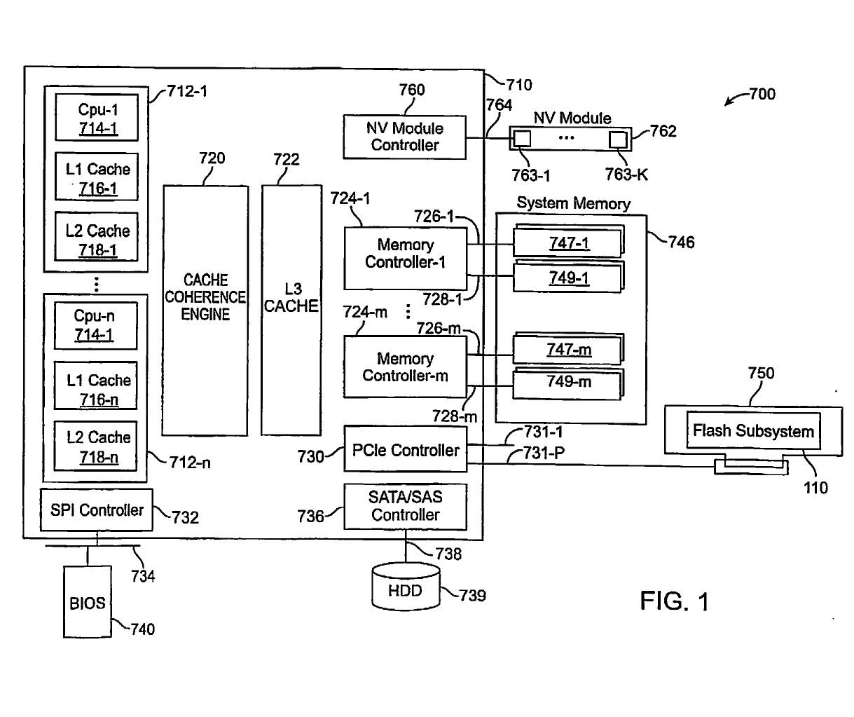

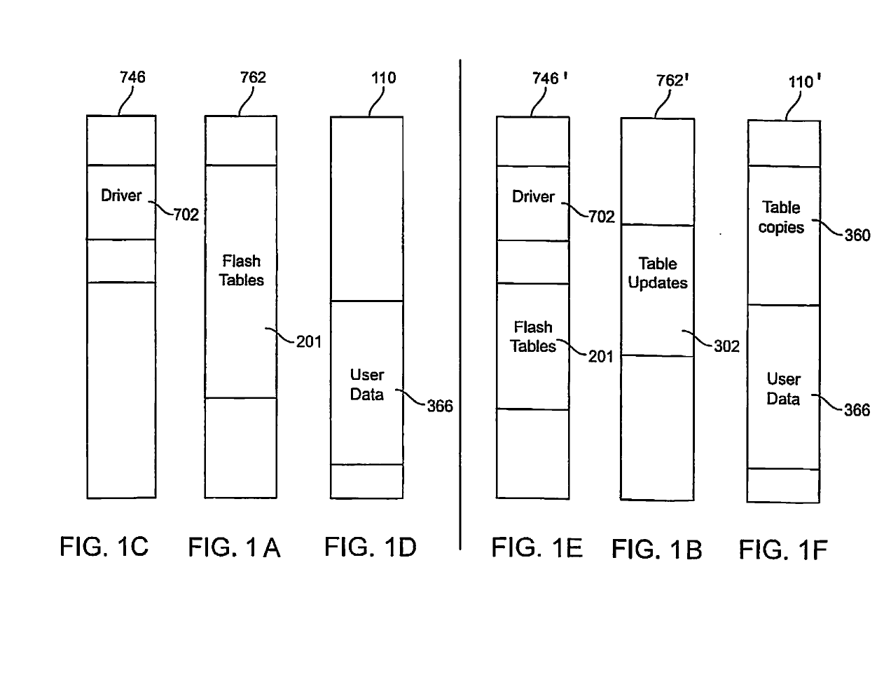

FIG. 1 shows a computer system 700, in accordance with an embodiment of the invention.

Figs. A, C, and D show exemplary contents of the system memory 762, the NV module 762, and the flash subsystem 110, in accordance with an embodiment of the invention.

Figs. B, E, F show exemplary contents of the system memory 746, the NV module 762′ and the flash subsystem 110, in accordance with another embodiment of the invention.

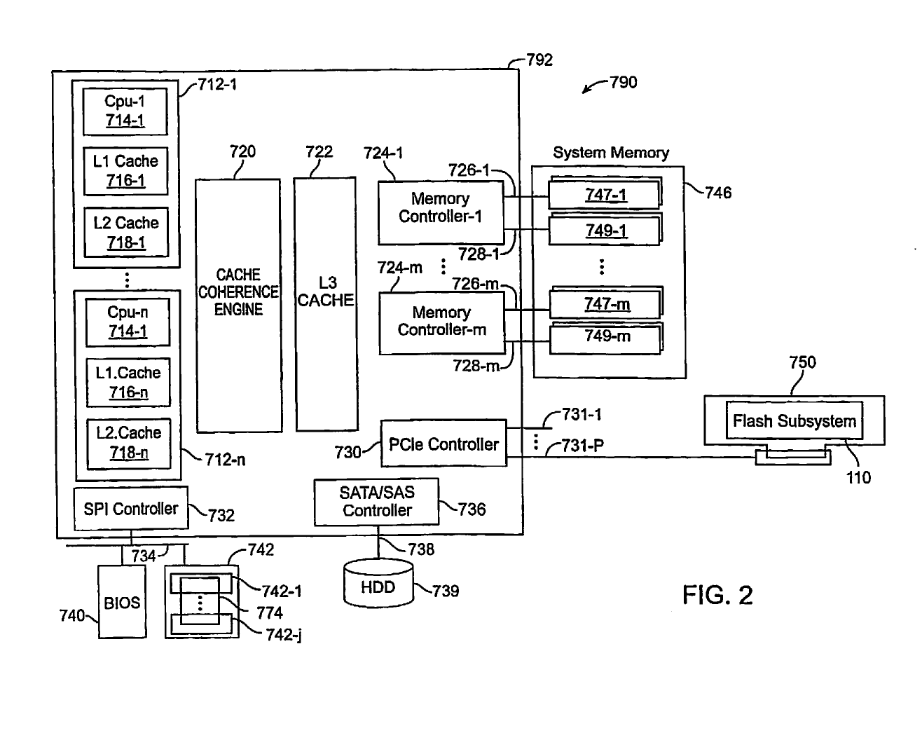

FIG. 2 shows a computer system 790, in accordance with another embodiment of the invention.

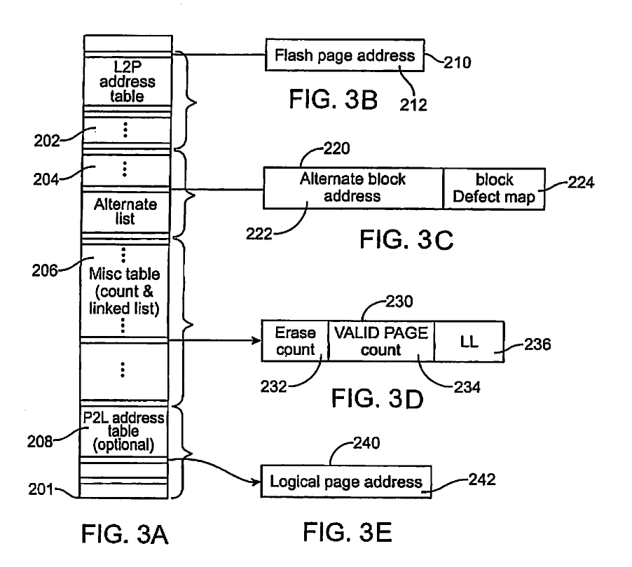

FIG. 3A shows further details of the table 201.

FIG. 3B shows further details of the entry 212 of table 202.

FIG. 3C shows further details of the entry 220 of table 204.

FIG. 3D shows further details of the entry 230 of table 206.

FIG. 3E shows further details of the entry 240 of table 208 including field 242.

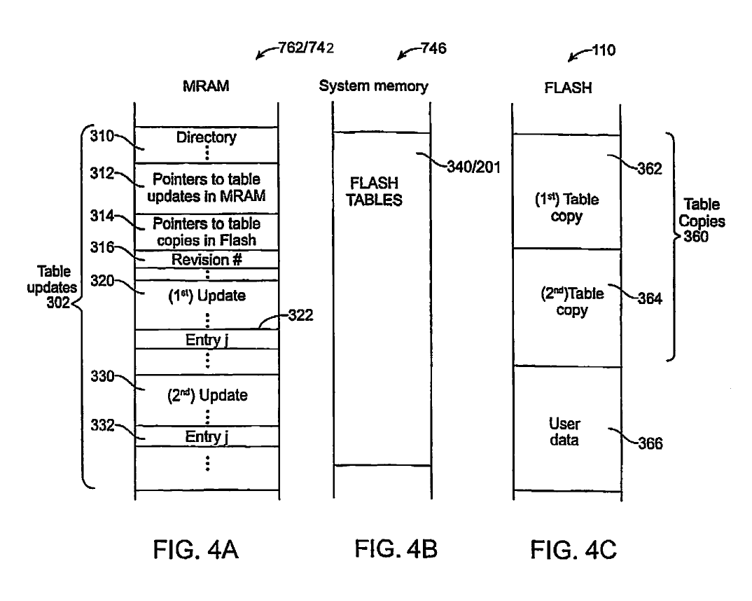

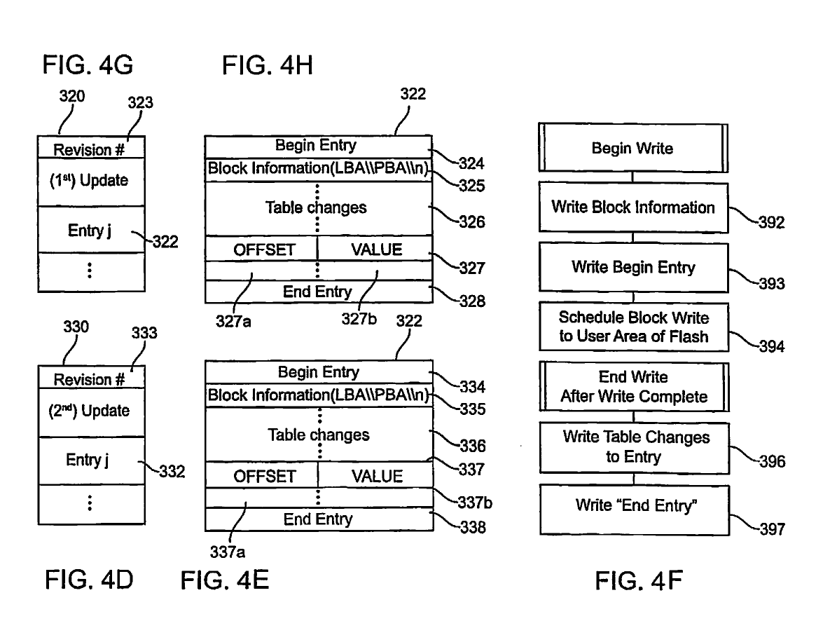

FIG. 4A-C show exemplary data structures stored in each of the MRAM 762/742, System Memory 746, and flash 110.

FIGS. 4H, 4E, 4G, and 4D show exemplary details of entries 322/332 in updates 320/330.

FIG. 4F shows a process flow of the relevant steps performed in writing an entry 322/332 in update 320/330.

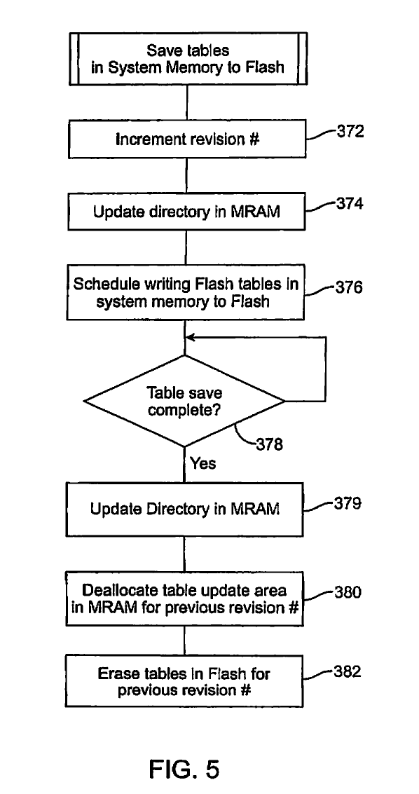

FIG. 5 shows a process flow of the relevant steps performed in saving flash tables in system memory to flash using the embodiments shown and discussed relative to other embodiments herein and in accordance with a method of the invention.

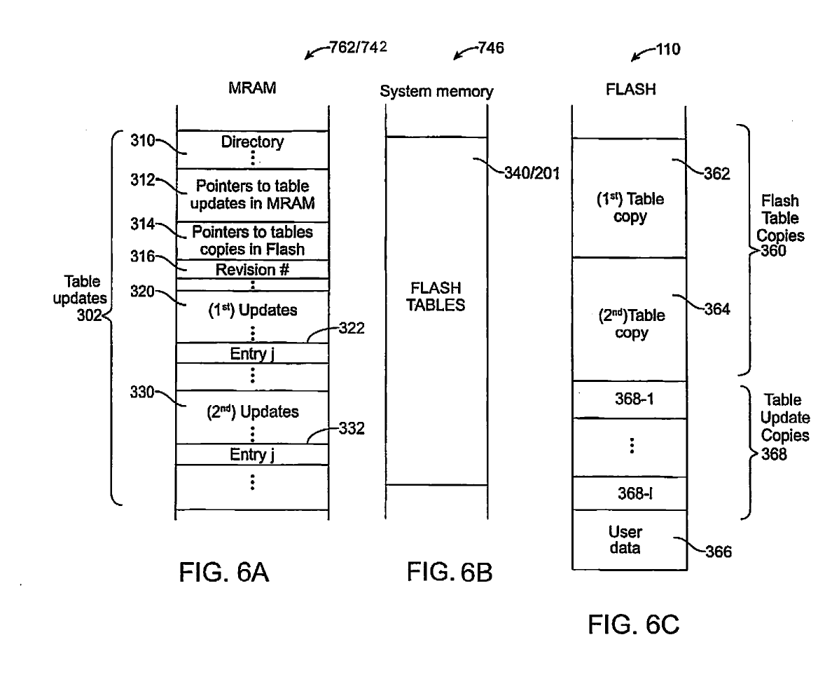

FIGS. 6A, B, and C show another exemplary data structures stored in each of the MRAM 762/742, System Memory 746, and flash 110 for yet another embodiment of the invention.

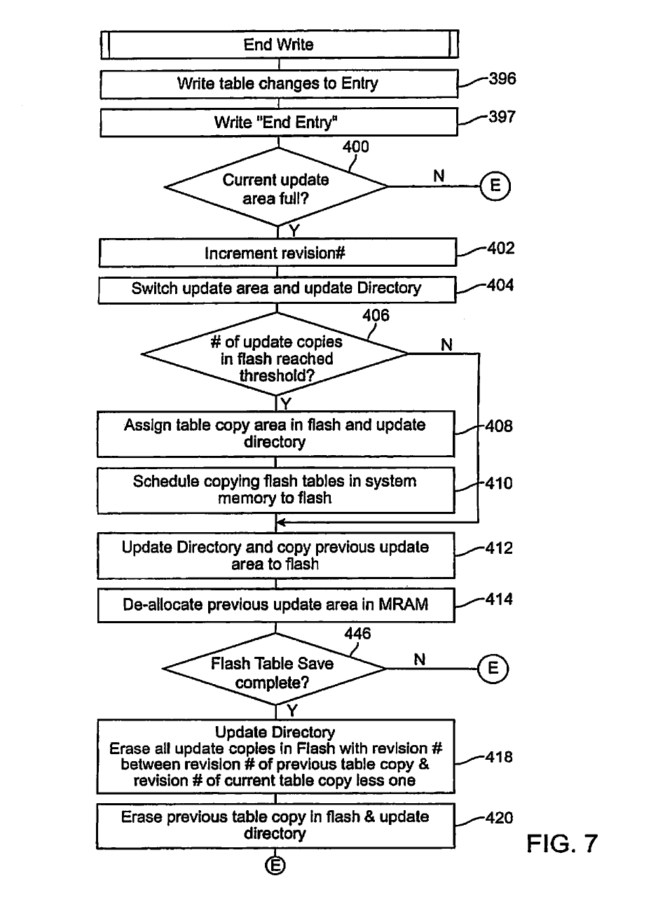

FIG. 7 shows a process flow of the relevant steps performed in saving updates and flash tables in system memory to flash using the embodiments shown and discussed relative to other embodiments herein and in accordance with a method of the invention.

### DETAILED DESCRIPTION OF THE VARIOUS EMBODIMENTS

Referring now to FIG. 1, a computer system 700, in accordance with an embodiment of the invention. The system 700 is shown to include a Central Processor Unit (CPU) 710, a system memory 746, a non-volatile (NV) memory module 762, a basic input and output system (BIOS) 740, an optional HDD 739, and a physically-addressed solid state disk (SSD) 750, in accordance with an embodiment of the invention. In FIG. 1, the CPU 710, BIOS 740, optional HDD 739, system memory 746, and NV memory module 762 collectively form a host.

The CPU 710 of system 700 is shown to include a bank of CPU cores 712-1 through 712-n, a shared last level cache (in this example L3 Cache) 722, a cache coherency engine 720, a bank of memory controllers 724-1 through 724-m shown coupled to a bank of memory channels 726-1 through 726-m and 728-1 through 728-m, a PCIe controller 730, shown coupled to a bank of PCIe busses 731-1 through 731-p, an NV module controller 760, shown coupled to the NV module 762, an optional SATA/SAS controller 736, shown coupled to a hard disk drive (HDD) 739, an (SPI) controller 732, which is shown coupled to BIOS 740.

The NV module 762 includes a bank of MRAMs 763-1 through 763-k that are shown coupled to the NV module controller 760 via the NV memory channel 764. In an embodiment of the invention, the NV memory channel 764 is analogous to the memory channels 726/728 and the NV module controller 760 is analogous to the memory controller 724.

The NV memory channel 764 couples the NV module 762 to the NV module controller 760 of the CPU 710. In an embodiment of the invention, the NV memory channel 764 is a DRAM memory channel.

In some embodiments, the flash subsystem 110 is made of flash NAND memory. In some embodiment, the flash subsystem 110 is made of flash NOR memory.

The system memory 746 is shown to include a bank of volatile RAM (DRAM) modules 747-1 through 747-m that are coupled to the memory controllers 724-1 through 724-m via the memory channels 726-1 through 726-m and the modules 749-1 through 749-m are coupled to the memory controllers 724-1 through 724-m via the memory channels 728-1 through 728-m.

The CPU 710 of system 700 is shown to include a physically addressed solid state disk 750, wherein the blocks are addressed with a physical rather than a logical address The SSD 750 includes flash subsystem 110. In the system 700 of FIG. 1, flash block management is performed by a software driver (also known herein as the “driver”) 702 that is loaded during the system 700's initialization, after power up. In addition to user commands, commands sent to the SSD 750 include commands for flash management (including garbage collection, wear leveling, saving flash tables, . . . ) and these commands use physical address rather than logical address.

In one embodiment of the invention, as shown in FIG. 1a, the flash table 201 is saved in the non-volatile memory module 762 that is made of MRAMs 763-1 thru 763-k.

FIGS. 1A, C, and D show exemplary contents of the system memory 746, the NV module 762, and the flash subsystem 110, in accordance with an embodiment of the invention. The system memory 746 is shown to include a driver 702, the NV module 762 is shown to include the flash tables 201, and the flash subsystem 110 is shown to include the user data 366. The driver 702 performs flash block management. The flash tables 201 are tables generally used for management of the flash memory blocks within the SSD 750 and the user data 366 is generally information received by the physically addressed solid state disk 750 from the host to be saved. The flash tables 201 include tables used for managing flash memory blocks, further details of which are shown in FIG. 3A. The driver 702 generally manages the flash memory blocks. As shown in FIG. 1A, the flash table 201 is maintained in module 762.

As noted above, the flash subsystem 110 is addressed using physical and not logical addresses, provided by the host.

In an alternate embodiment, the flash tables 201 are maintained in the system memory 762 and are substantially periodically saved in the flash subsystem 110 of the physically addressed SSD 750, and the parts of the tables 201 that are updated (modified) since the previous save being additionally saved in the non-volatile memory module 762.

FIGS. 1B, E, and F show exemplary contents of the system memory 746, the NV module 762′ and the flash subsystem 110, in accordance with another embodiment of the invention. In FIG. 1E, the system memory 746 is shown to include the driver 702 in addition to the flash tables 201, the NV module 762′ is shown to include the table updates 302, and the flash subsystem 110, in FIG. 1F is shown to include table copies 360 and the user data 366. As previously noted, the flash tables 201 are tables that are generally used for management of blocks within the SSD 750. The table updates 302, in FIG. 1B, is generally updates to the flash tables 201, in FIG. 1E, since the last copy of the flash tables 201 was initiated until a subsequent copy is initiated. The table copies 360 are snapshots of the flash tables 201 that are saved in the flash subsystem 110. This is further explained in U.S. patent application Ser. No. 13/570,202, filed on Aug. 8, 2012, by Siamack Nemazie and Ngon Van Le, and entitled “SOLID STATE DISK EMPLOYING FLASH AND MAGNETIC RANDOM ACCESS MEMORY (MRAM)”. The user data 366 is information provided by the host.

In some embodiments, the NV module 762 includes spin torque transfer MRAM (STTMRAM).

In some embodiments, the NV module 762 is coupled to the CPU 710 via a system bus. An exemplary system bus is Serial Protocol Interconnect (SPI).

Accordingly, in the computer system 700 the flash tables 201 are used to manage blocks in the physically addressed SSD 750. The flash tables 201 include tables that are used to map logical blocks to physical blocks for identifying the location of stored data in the physically addressed SSD 750 and the flash tables are maintained in the NV module 762, which advantageously avoids reconstruction of the flash tables upon power interruption of the system 700.

FIG. 2 shows a computer system 790, in accordance with another embodiment of the invention. The system 790 is analogous to the system 700 except that the system 790 further includes MRAM 742 and the BIOS 740, both shown coupled through the SPI bus 734 to the CPU 792, which is analogous to the CPU 710 of FIG. 1. Therefore, in the system 790, the NV module 762, shown coupled to NV memory channel of FIG. 1, is removed and replaced with MRAM 742, which includes a bank of MRAM devices 742-1 through 742-j that are coupled to a system bus. In the embodiment of FIG. 2 the system bus coupling the MRAM 742 to the CPU 792 is the SPI bus 734.

The system 790 is another exemplary embodiment of a system that can be used to implement the tables of FIGS. 1A to 1F.

As in system 700, in system 790 of FIG. 2, the flash block management is performed by a software driver 702 loaded during system initialization after power up. In the embodiment of FIG. 2 tables are maintained in system memory 746 and are near periodically saved in flash subsystem 110 onboard the physically addressed SSD 750 and the parts of the tables that are updated since last save are additionally maintained in 742 comprised of plurality of MRAM devices 742-1 through 742-j coupled to CPU 792 though a system bus such as SPI. In the embodiment of FIG. 2 the Flash table 201 is maintained in system memory 746, table updates 774 in MRAM 742 and table copies 776 in flash subsystem 110.

In one embodiment of FIG. 1A, flash table 201 is saved in the non-volatile memory module 762 comprised of MRAMs 763-1 thru 763-k. In the embodiment of FIG. 3A, flash table 201 is saved in the system memory 746.

Further, as shown in FIG. 3A, it typically includes various tables. For example, the table 201 is shown to include a logical address-to-physical address table 202, a defective block alternate table 204, a miscellaneous table 206, and an optional physical address-to-logical address table 208. A summary of the tables within the table 201 is as follows:
Logical Address to Physical (L2P) Address Table 202
Defective Block Alternate Table 204
Miscellaneous Table 206
Physical Address to Logical (P2L) Address Table (Optional) 208

The table 202 (also referred to as “L2P”) maintains the physical page address in flash corresponding to the logical page address. The logical page address is the index in the table and the corresponding entry 210 includes the flash page address 212.

The table 220 (also referred to as “Alternate”) keeps an entry 220 for each predefined group of blocks in the flash. The entry 220 includes a flag field 224 indicating the defective blocks of a predefined group of blocks, the alternate block address field 222 is the address for substitute group block if any of the blocks is defective. The flag field 224 of the alternate table entry 220 for a grouped block has a flag for each block in the grouped block, and the alternate address 222 is the address of substitute grouped block. The substitute for a defective block in a grouped block is the corresponding block (with like position) in the alternate grouped block.

The table 206 (also referred to as “Misc”) keeps an entry 230 for each block for miscellaneous flash management functions. The entry 230 includes fields for block erase count (also referred to as “EC”) 232, count of valid pages in the block (also referred to as “VPC”) 234, various linked list pointers (also referred to as “LL”) 236. The EC 232 is a value representing the number of times the block is erased. The VPC 234 is a value representing the number of valid pages in the block. Linked Lists are used to link a plurality of blocks for example a Linked List of Free Blocks. A Linked List includes a head pointer; pointing to first block in the list, and a tail pointer pointing to the last element in the list. The LL 236 field points to the next element in the list. For a double linked list the LL field 236 has a next pointer and a previous pointer. The same LL field 236 may be used for mutually exclusive lists, for example the Free Block Linked List and the Garbage Collection Linked List are mutually exclusive (blocks can not belong to both lists) and can use same LL field 236. Although only one LL field 236 is shown for Misc entry 230 in FIG. 3d, the invention includes embodiments using a plurality of Linked List fields in the entry 230.

The physical address-to-logical address (also referred to as “P2L”) table 208 is optional and maintains the logical page address corresponding to a physical page address in flash; the inverse of L2P table. The physical page address is the index in the table 208 and the corresponding entry 240 includes the logical page address field 242.

The size of some of the tables is proportional to the capacity of flash. For example the L2P table 202 size is (number of pages) times (L2P table entry 210 size), and number of pages is capacity divided by page size, as a result the L2P table 202 size is proportional to capacity of the flash subsystem 110.

Another embodiment of FIG. 1 that uses a limited amount (i.e. not scaled with capacity of the flash subsystem 110) of MRAM in non-volatile memory module 762 will be presented next. In this embodiment the tables are maintained in system memory The tables in system memory 746 are near periodically and/or based on some events (such as a Sleep Command, or number of write commands since last copy back) are copied back to the flash subsystem 110. The updates to tables in between copy back to flash are additionally written to the non-volatile memory module 762, and identified with a revision number. The updates associated with last two revisions number are maintained and updates with other revision number are not maintained. When performing table save concurrent with host commands, to minimize impact on latency and performance, the table save operation is interleaved with the user operations at some rate to guarantee completion prior to next copy back cycle. Upon power up, the last saved copy of tables in flash are copied to system memory 746 and appropriate updates in the non-volatile memory are applied to the tables to reconstruct the last state of tables.

FIG. 3A shows further details of the table 201. FIG. 3B shows further details of the entry 212 of table 202. FIG. 3C shows further details of the entry 220 of table 204. The entry 220 is shown to include the fields 222 and 224. FIG. 3D shows further details of the entry 230 of table 206. The entry 230 is shown to include the fields 232, 234, and 236. FIG. 3E shows further details of the entry 240 of table 208 including field 242.

FIGS. 4A-C show exemplary data structures stored in each of the MRAM 762/740, system memory 746, and the flash subsystem 110 of the embodiments of prior figures. The data structures in the system memory 746 include flash tables 340. The data structure in the flash subsystem 110 includes a first copy 362 and a second copy 364 of the tables 340 in the system memory 746, copies 362 and 364 are identified with a revision number, revision numbers are sequential, the current copy being associated with a larger revision number and the previous copy with a smaller revision number. The copies 362 and 364 are similar to a snapshot (snapshots taken from the time that copy to flash was initiated till the time the copy is completely written to flash) and updates to table 340 since the snapshot was initiated till the next snapshot is initiated would be missing from copy in flash and are saved in MRAM 762/740. The data structures in the MRAM 762/740 include the directory 310, a first updates 320 to the tables, a second update 330 to the tables, pointers 312, pointers 314, and revision number 316. As shown in FIG. 4C, 4 information from host (also referred to as “user data”) 366 is stored in the flash subsystem 110.

The current update in MRAM 762/740 alternates between the first update 320 and the second update 330, when a copy of flash tables 340/201 in system memory 746 to the flash subsystem 110 is initiated. After the copy is successfully written to flash the previous update in MRAM 762/740 is de-allocated. Similarly the current copy in flash alternates between the first copy 362 and the second copy 364. After the copy is successfully written to flash the previous copy in the flash subsystem 110 is erased.

The pointers 314 is a table of pointers to locations in the flash subsystem 110 where the copies 362 and 364 are located includes a first pointers for first copy 362 and a second pointer for the second copy 364. The pointers 312 is a table of pointers pointing to addresses in the MRAM 762/740 where updates 320 and 330 are located. The revision number 316, is a table of entries where revision number associated with first copy 362 and second copy 364 and corresponding updates are saved. The directory 310 includes pointers to the above tables.

The revision number additionally includes a flags field, the flags field to indicate the state of the tables (table updates and table copies) associated with the revision number. The flags and associated states are shown in an exemplary table below:

Table 1 shows: update/copy States and associated with flags in revision #

| Flags | | | |
|---|---|---|---|
| f2 | f1 | f0 | State |
| 0 | 0 | 0 | Not Used: De-Allocated previous update and |
| | | | Erased previous flash copy |
| 0 | 0 | 1 | Used |
| 0 | 1 | 1 | Flash Copy In Progress |
| 0 | 1 | 0 | Flash Copy Completed and De-Allocation of |
| | | | previous update In Progress |
| 1 | 1 | 0 | De-Allocation of previous update completed |
| 1 | 0 | 0 | Erase of previous flash Copy In Progress |

The above table is exemplary of having persistent state associated with tables and copies, for example De-Allocation of previous update completed State can be combined to also indicate Erase of previous flash Copy In Progress State. Using flags is a means of providing various persistent state information about tables and copies other means fall within spirit of the invention.

FIG. 4A shows an exemplary contents for the table 320 and the table 330. Table 320 includes the associated revision number and a plurality of entries, the entry 322 is an exemplary entry in the updates 320. Table 330 includes the associated revision number and a plurality of entries, the entry 332 is an exemplary entry in the updates 330.

The entry 322 is shown to include of a Begin Entry 324 record, a Block Information 325 record, a Table Changes 326 record, and an End Entry 328 record. The Begin Record 324 is a record with a signature indicating beginning of a record, the Block Information 325 is record including LBA of Blocks being written, associated PBA, and length information including the length of the Entry 322. The Table Changes 326 record includes a plurality of table changes, the entry 327 is an exemplary table change in the record and includes two fields, an offset field 327a and a data field 327b, the offset field and the data field respectively identify a location and data used to update the location. For example, the offset field 327a indicates the offset from a location starting from the beginning of a table that is updated and the data field 327b indicates the new value to be used to update the identified location within the table. (offset 0 is reserved)

Entry 323 is analogous to entry 322.

Accordingly, the device 750 of FIG. 1 is configured to store information from the system via PCIe bus 731-p, in blocks at physical addresses, and the system memory 746 includes the flash tables 340 used for flash block management. The flash tables 340 maintain information used for flash block management in the device 750, including tables used to map logical to physical blocks for identifying the location of stored data in the SSD.

The flash subsystem 110 includes a plurality of flash devices that is configured to store copies (snapshots) of flash tables 340, the copies include a first copy 362 and a second copy 364, copies 362 and 364 are identified with a revision number, revision number additionally including a flags field to indicate the state of the tables, revision numbers are sequential, the current copy being associated with a larger revision number and the previous copy with a smaller revision number including. Updates to flash tables 340 from the time the copy to flash is initiated till the time the next copy to flash is initiated are additionally saved in MRAM 762 or 740 depending on the embodiment used and identified with same revision number. Further, the copies in flash along with updates in MRAM are used to reconstruct the flash tables of the system memory upon power interruption to the solid state storage device 750.

FIGS. 4H, 4E, 4G, and 4D show exemplary details of entries 322/332 in updates 320/330.

FIG. 4F shows a process flow of the relevant steps performed in writing an entry 322/332 in update 320/330 at the Beginning and Ending of writing to user data 366 in flash 110 using the embodiments shown and discussed above and in accordance with a method of the invention. The steps of FIG. 4b are generally performed by the CPU 710 of the system 700 of FIG. 1. The Begin Write process includes the following steps, at step 392 write block information in Block Information 325 record in current entry in the current update, next at step 393 write Begin Entry 324 record in the current entry 322 in current update, next at 394 writing the blocks of data to user area in flash is scheduled. The End Write process includes the following steps after completion of write to user area: At step 396 write Table Changes 326 record in current entry in current update, at step 397 write End Entry 328 record in current entry in current update. The above steps allows crash recovery, to clean up flash area and tables in the event of a crash or power failure. Briefly in accordance with embodiments of the invention an Entry not including a valid End Entry indicates a crash occurred and Table Changes 326 can be ignored an Entry with a valid Begin Entry and with an invalid End Entry indicates possible crash during writing user data and possible dirty flash blocks, information about location of dirty blocks is in Block Information Field and can be used for cleaning up dirty blocks in flash 110.

FIG. 5 shows a process flow of the relevant steps performed in—saving flash tables in system memory to flash using the embodiments shown and discussed above and in accordance with a method of the invention. The steps of FIG. 5 are generally performed by the CPU 710 of the system 700 of FIG. 1.

In FIG. 5, at step 372, the value of current revision number is incremented, first the current revision number is identified and then the value of current revision number is incremented. Note that at this point, the flag field associated with current revision number is 010 (Flash Copy Completed), and the flag field associated with previous revision number is 000 (Not Used; i.e De-Allocated previous update and Erased Flash Copy for previous revision).

Next, at step 347, the directory 310 that resides in the MRAM 762 or 740 is updated. Directory 310 update includes following:
write the incremented value of current revision number with flag 001 (indicating being Used) to the entry in revision 316 table associated with previous revision which will cause this entry to becomes current revision (a higher revision number) in a transitory state (i.e. being Used) and what was the current revision before becomes previous revision (a lower revision number),
assign addresses (block and or page) in flash for the location of copy in flash,
write the assigned flash addresses to the entry in pointers 314 table associated with previous revision,

Next, at step 376, the copying of tables 340 from the system memory 746 to the flash 110 is scheduled and started. As mentioned before to minimize impact on latency and performance, the table copy operation is interleaved with the user operations at some rate to guarantee completion prior to next copy back cycle. Next, at step 378, a determination is made of whether or not the copying of step 376 to flash is completed and if not, time is allowed for the completion of copying, otherwise, the process continues to step 379.

Step 378 is performed by “polling”, known to those in the art, alternatively, rather than polling, an interrupt routine is used in response to completion of flash write fall within scope of invention. Other methods, known to those in the art, fall within the scope of invention.

Next, at step 379, directory 310 is updated, the flag associated with current revision number is updated to 010 (Flash Copy Completed), and the process continues to step 380.

Next, at step 380, the update area in the MRAM 762 or 740 allocated to updates of previous revision number is de-allocated, the steps include following:
write a predefined value indicating invalid value (in this example all zero; offset zero is reserved) to the update area in the MRAM 762 or 740 allocated to updates of previous revision number, (this is to enable locating last address written in updates in the event of power interruption)
the flag associated with previous revision number is updated to 110 (De-Allocation Completed)

At step 382, the table for the previous revision number 362 in the flash 110 is erased, the steps include following:
the flag associated with previous revision number is updated to 100 (Erase Flash Copy In Progress)
the blocks in flash corresponding to table copies associated with previous version are erased, and flash tables in system memory are updated accordingly
the flag associated with previous revision number is updated to 000 (Erase Flash Copy In Progress)

When copy is completed at 378 and Directory updated at step 379, the current copy in the flash 110, along with updates to tables in MRAM with current revision number can advantageously completely reconstruct the tables 340 in the event of a power fail.

If copy is not completed at 378 or the Directory 310 is not updated at step 379 due to power interruption (the associate state/flag is Flash Copy In progress 011), the previous revision copy in the flash 110, along with both previous revision and current revision updates to tables in MRAM can advantageously completely reconstruct the tables 340 in the event of a power fail.

FIGS. 6A, B, and C show another exemplary data structures stored in each of the MRAM 762/740, system memory 746, and flash 110 of the embodiments of prior figures. In FIG. 6, it is shown that table update copies are additionally stored in flash 110 in order to reduce the size of updates in MRAM 762/740 and frequency of flash table copy back to flash 110. One or more of the updates along with associated revision number are additionally saved in Flash 110. The current update in MRAM 762/740 alternates between the first update 320 and the second update 330, when one update is near full it switches to the other update and copies the previous update to flash 110, and then de-allocates the previous update in MRAM. a copy of flash tables 340/201 in system memory 746 to flash 110 is initiated after a predetermined number of updates are copied to flash, and during table copy, as the updates alternate the previous is copied to flash. After the table copy is successfully written to flash the previous updates in flash are erased. the current version of the block management table in flash along with past updates saved in flash and recent updates saved in MRAM is used to reconstruct the flash block management tables in system memory upon system power up.

FIG. 7 shows a process flow of the relevant steps performed in saving flash updates and flash tables in system memory to flash using the embodiments shown and discussed above and in accordance with a method of the invention. The steps of FIG. 7 are generally performed by the CPU 710 of the system 700 of FIG. 1.

The End Write process includes the following steps after completion of write to user area: At step 396 write Table Changes 326 record in current entry in current update, next at step 397 write End Entry 328 record in current entry in current update.

Next at step 400 a determination is made if the current update is full. If current update area is not full the process exits (E) else moves to step 403. At step 403 the revision number is incremented and moves to step 404. Next at step 404 the directory 310 is update. The directory update includes following:
write the incremented value of current revision number with flag 001 (indicating being Used) to the entry in revision 316 table associated with previous revision which will cause this entry to becomes current revision (a higher revision number) in a transitory state (i.e. being Used) and what was the current revision before becomes previous revision (a lower revision number),

Next, at step 406 a determination is made if the number of update copies in flash reached a predefined threshold. If at step 406 it is determined that the number of update copies in flash has reached a threshold the process moves to step 408, else it moves to step 412. At step 408 table copy area in flash is assigned and the directory 310 is updated. Next at step 410 saving of flash tables in system memory to flash 110 is scheduled. Next at step 412 the directory is updated and the previous update area is copied to flash. Next at step 414 after completion of saving previous update area in MRAM to flash the previous update area in MRAM is de-allocated. Next at step 416 a determination is made if the previously scheduled flash table saves is completed. If it is determined that the save is not completed the process exists (E) else moves to step 418. At step 418 the directory 310 is updated and all update copies in Flash with revision number between revision # of previous table copy and revision number of current table copy less one are erased. Next at step 420 the previous table copy in flash is erased and the directory 310 updated.

Although the invention has been described in terms of specific embodiments, it is anticipated that alterations and modifications thereof will no doubt become apparent to those skilled in the art. It is therefore intended that the following claims be interpreted as covering all such alterations and modification as fall within the true spirit and scope of the invention.

What is claimed is:

1. A computer system comprising:
a Central Processing Unit (CPU):
a physically-addressed solid state disk (SSD) that is addressable using physical addresses associated with user data, provided by a host, to be stored in or retrieved from the physically-addressed SSD in blocks;
a non-volatile memory module coupled to the CPU, the non-volatile memory module including flash tables used to manage blocks in the physically addressed SSD, the flash tables including tables used to map logical to physical blocks for identifying the location of stored data in the physically addressed SSD,
wherein the flash tables are maintained in the non-volatile memory modules thereby avoiding reconstruction of the flash tables upon power interruption.

2. The computer system, as recited in claim 1, wherein the physically-addressed solid state disk (SSD) includes a flash subsystem.

3. The computer system, as recited in claim 2, wherein the flash subsystem is made of flash NAND memory.

4. The computer system, as recited in claim 6, wherein the flash subsystem is made of flash NOR memory.

5. The computer system, as recited in claim 1, wherein the non-volatile memory module includes MRAM.

6. The computer system, as recited in claim 1, wherein the non-volatile memory module includes STTMRAM.

7. The computer system, as recited in claim 1, wherein the non-volatile memory module is coupled to the CPU through a NV memory channel.

8. The computer system, as recited in claim 7, wherein the NV memory channel is a DRAM memory channel.

9. The computer system, as recited in claim 1, wherein the NV memory module is coupled to the CPU via a system bus.

10. The computer system, as recited in claim 9, wherein the system bus is a Serial Peripheral Interface bus.

11. The computer system, as recited in claim 1, further including a system memory coupled to the CPU and configured to store software driver for managing the flash tables.

12. A computer system comprising:
a Central Processing Unit (CPU):
a physically-addressed solid state disk (SSD) that is addressable using physical addresses associated with user data, provided by a host, to be stored in or retrieved from the physically-addressed SSD in blocks;
a system memory coupled to the CPU, the system memory including flash tables used to manage blocks in the physically addressed SSD, the flash tables including tables used to map logical to physical blocks for identifying the location of stored data in the physically addressed SSD,
the physically-addressable SSD includes a flash subsystem that includes flash memory configured to save snapshots of the flash tables including a previous version of the flash tables and a current version of the flash tables under the direction of the CPU, the non-volatile memory module including a magnetic random access memory (MRAM) configured to store changes to the flash tables,
wherein the current version of the snapshot of the flash tables is used to reconstruct the flash tables upon power interruption.

13. The computer system, as recited in claim 12, wherein the flash subsystem is made of flash NAND memory.

14. The computer system, as recited in claim 13, wherein the flash subsystem is made of flash NOR memory.

15. The computer system, as recited in claim 12, wherein the non-volatile memory module includes MRAM.

16. The computer system, as recited in claim 12, wherein the non-volatile memory module includes STTMRAM.

17. The computer system, as recited in claim 12, wherein the non-volatile memory module is coupled to the CPU through a memory channel.

18. The computer system, as recited in claim 17, wherein the NV memory channel is a DRAM memory channel.

19. The computer system, as recited in claim 12, wherein the NV memory module is coupled to the CPU via a system bus.

20. The computer system, as recited in claim 12, wherein system memory is configured to store a software driver for managing the flash tables.
